(19) United States
(12) Patent Application Publication
(10) Pub. No.: US 2025/0062391 A1
(43) Pub. Date: Feb. 20, 2025

(54) LITHIUM ION CELLS INCLUDING COATED SOLID-STATE ELECTROLYTES AND METHODS OF FORMING THE SAME

(71) Applicant: GM GLOBAL TECHNOLOGY OPERATIONS LLC, Detroit, MI (US)

(72) Inventors: Sayed Youssef Sayed Nagy, Troy, MI (US); Caleb Reese, Ferndale, MI (US)

(73) Assignee: GM GLOBAL TECHNOLOGY OPERATIONS LLC, Detroit, MI (US)

(21) Appl. No.: 18/450,601

(22) Filed: Aug. 16, 2023

(51) Int. Cl. H01M 10/0525; H01M 4/1391

(52) U.S. Cl. CPC H01M 10/0525; H01M 4/1391; H01M 2220/20; H01M 2300/002

(57) ABSTRACT

Lithium ion cells and methods for producing such cells are provided. The lithium ion cells include a lithium metal anode that includes a current collector and a lithium metal layer, a cathode having a lithium intercalation material, and a solid-state electrolyte (SSE) having a lithiophilic layer on a surface of the SSE. The lithiophilic includes a metal oxide. In one example, the lithiophilic layer is formed by depositing a non-aqueous precursor solution on the surface of a solid-state electrolyte (SSE), wherein the precursor solution includes a metallic nitrate, and decomposing the precursor solution to form the lithiophilic layer.

### INTRODUCTION

The technical field generally relates to lithium ion batteries, and more particularly relates to solid-state electrolytes having a coating layer on a surface thereof.

High-energy-density rechargeable batteries, such as lithium ion batteries, are used in a plurality of applications including consumer electronics and electric vehicles. While significant improvements to these batteries have been achieved, there are ongoing efforts to produce new battery configurations with improved overall performance and/or reduced size.

Accordingly, it is desirable to provide high-energy-density rechargeable batteries with improved performance and/or reduced size. Furthermore, other desirable features and characteristics of the present invention will become apparent from the subsequent detailed description and the appended claims, taken in conjunction with the accompanying drawings and the foregoing technical field and background.

### SUMMARY

A lithium ion cell is provided that, in one example, includes a lithium metal anode that includes a current collector and a lithium metal layer, a cathode having a lithium intercalation material, and a solid-state electrolyte (SSE) having a lithiophilic layer on a surface of the SSE. The lithiophilic layer includes a metal oxide.

In various examples, the lithium ion cell is a hostless cell wherein lithium metal is plated on the current collector during charge of the lithium ion cell to define a plated lithium layer between the current collector and the lithiophilic layer.

In various examples, the lithiophilic layer has a thickness of between 20 nanometers to 100 nanometers.

In various examples, the metal oxide is an oxide of zinc, indium, tin, aluminum, or bismuth.

In various examples, the surface of the SSE is lithiophobic.

In various examples, the SSE is a garnet-type SSE (LLMO) that includes a composition comprising lithium, lanthanum, oxygen, and one of zirconium, niobium, or tantalum.

A method is provided that, in one example, includes depositing a non-aqueous precursor solution on a surface of a solid-state electrolyte (SSE), and decomposing the precursor solution and form a lithiophilic layer on the surface of the SSE. The precursor solution includes a metallic nitrate. The lithiophilic layer includes a metal oxide.

In various examples, the method includes forming a lithium metal layer between the lithiophilic layer and a current collector to define a lithium metal anode that includes the current collector and the lithium metal layer, and assembling the SSE between the lithium metal anode and a cathode to define a lithium ion cell. The cathode includes a lithium intercalation material.

In various examples, the SSE and the lithium metal anode are assembled by performing a pressing process wherein the lithium metal layer is located between the current collector and the lithiophilic layer of the SSE at a pressure below 100 MPa.

In various examples, the SSE and the lithium metal anode are assembled by locating the current collector in proximity to the lithiophilic layer of the SSE, and filling a space therebetween with molten lithium metal.

In various examples, the lithium ion cell produced by the method is a hostless cell configured to have lithium metal plated on the current collector during charge of the lithium ion cell to define a plated lithium layer between the current collector and the lithiophilic layer of the SSE.

In various examples, the lithiophilic layer is formed to have a thickness of between 20 nanometers to 100 nanometers.

In various examples, the metal oxide is an oxide of zinc, indium, tin, aluminum, or bismuth.

In various examples, depositing the precursor solution is performed by a spin coating process. In various examples, the method includes controlling a thickness of the lithiophilic layer by controlling a concentration of the metallic nitrate in the precursor solution, and by controlling, during the spin coating process, a rotational speed of the SSE, a temperature of the SSE, and distance between the surface of the SSE and a source of the precursor solution.

In various examples, the SSE is a garnet-type SSE (LLMO) that includes a composition comprising lithium, lanthanum, oxygen, and one of zirconium, niobium, or tantalum.

A vehicle is provided that, in one examples, includes a lithium ion battery including a lithium ion cell and a propulsion system configured to receive electric power from the lithium ion battery. The lithium ion cell includes a lithium metal anode that includes a current collector and a lithium metal layer, a cathode having a lithium intercalation material, and a solid-state electrolyte (SSE) having a lithiophilic layer on a surface of the SSE. The lithiophilic layer includes a metal oxide. The surface of the SSE is lithiophobic. Lithium metal is plated on the current collector during charge of the lithium ion cell to define a plated lithium layer between the current collector and the lithiophilic layer.

In various examples, the lithiophilic layer has a thickness of between 20 nanometers to 100 nanometers.

In various examples, the metal oxide is an oxide of zinc, indium, tin, aluminum, or bismuth.

In various examples, the SSE is a garnet-type SSE (LLMO) that includes a composition comprising lithium, lanthanum, oxygen, and one of zirconium, niobium, or tantalum.

### BRIEF DESCRIPTION OF THE DRAWINGS

The examples will hereinafter be described in conjunction with the following drawing figures, wherein like numerals denote like elements, and wherein:

FIGS. 1, 2, and 3 are schematic diagrams presenting an exemplary lithium ion cell in an uncycled (as-assembled) state, a discharged state, and a charged state, respectively, is in accordance with an example;

FIGS. 4 and 5 are enlarged views of an interface between a solid-state electrolyte and a current collector of FIGS. 2 and 3, respectively, in accordance with an example;

FIG. 6 is a flow diagram illustrating a method of coating a solid-state electrolyte in accordance with an example; and

FIG. 7 is a functional block diagram of an exemplary vehicle comprising a lithium ion battery in accordance with an example.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

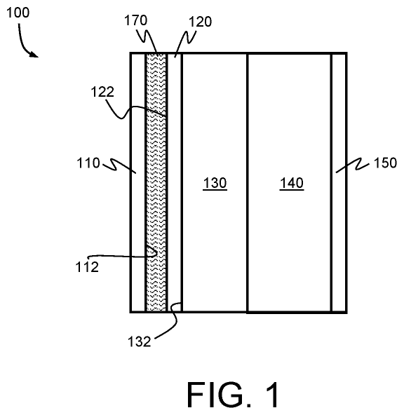

Referring initially to FIGS. 1-5, an exemplary lithium ion cell 100 is presented. In various examples, the lithium ion cell 100 may be one of a plurality of lithium ion cells within a lithium ion battery. The lithium ion cell 100 and/or the lithium ion battery that includes the lithium ion cell 100 may be used to provide electrical power to various electronic devices, such as but not limited to, electric vehicles, consumer electronics, etc.

The lithium ion cell 100 includes a lithium metal anode that includes a first current collector 110 (also referred to as the anode-side current collector 110) and a lithium metal layer (either an initial lithium metal layer 170 or a plated layer 160), a solid-state electrolyte (SSE) 130 that includes a lithiophilic layer 120 on a surface 132 thereof, a cathode 140, and a second current collector 150 (also referred to as the cathode-side current collector 150). In this example, the lithium ion cell 100 is configured as an “anode-free” or “hostless” lithium ion cell, that is, the lithium ion cell 100 does not include an anode host material (e.g., graphite) configured as a matrix for receiving and storing lithium ions (Li⁺) from the cathode 140. Instead, the lithium ion cell 100 is configured for lithium metal (Li⁰) to be plated directly on a surface 112 of the anode-side current collector 110 during charging of the lithium ion cell 100, resulting in a plated lithium layer 160 in direct contact with the surface 122 of the lithiophilic layer 120, as described in more detail below.

The lithium metal anode includes lithium metal as an active anode material. In an initial, as-assembled state of the lithium ion cell 100, the lithium metal anode may include the initial lithium metal layer 170 comprising a lithium metal (e.g., an Li thin film or foil), for example, pressed between the anode-side current collector 110 and the SSE 130. The anode-side current collector 110 may be formed of various materials including those used in the art for lithium ion anode-side current collectors. In some examples, the anode-side current collector 110 may include or be formed of copper or an alloy thereof. In some examples, the anode-side current collector 110 may be a metal layer (e.g., a thin film or foil).

The SSE 130 may be formed of various materials including those in the art for lithium ion SSEs. In some examples, the SSE 130 may be an oxide-based SSE. In some examples, the SSE 130 may be formed of or include a garnet-type Li-ion conducting in material (LLMO) that includes a composition comprising lithium, lanthanum, oxygen, and one of zirconium, niobium, or tantalum (i.e., M is Zr, Nb, or Ta). As a specific example, the SSE 130 may include or be formed of Li₇La₃Zr₂O₁₂ (LLZO).

The lithiophilic layer 120 is configured to promote wettability of the surface 132 of the SSE 130 with lithium. In some examples, the lithiophilic layer 120 has a drop contact angle with liquid lithium metal that is greater than a drop contact angle with liquid lithium metal of the SSE 130. In some examples, the SSE 130 may be lithiophobic, that is, having a drop contact angle with liquid lithium metal of less than ninety degrees. In contrast, the lithiophilic layer 120 is lithiophilic, that is, having a drop contact angle with liquid lithium metal of greater than ninety degrees. In examples such as those noted above, the wettability of the SSE 130 with lithium metal may be significantly improved.

In various examples, the lithiophilic layer 120 includes or is formed of a metal oxide that is lithiophilic. For example, the metal oxide may include or be formed of zinc oxide (ZnO), indium oxide (In₂O₃), tin oxide (SnO or SnO₂), aluminum oxide (Al₂O₃), or bismuth oxide (Bi₂O₃). In some examples, the lithiophilic layer 120 has a thickness in a range of around/about 20 nanometers to around/about 100 nanometers. Thickness within this range are believed to promote wettability of lithium metal while maintaining sufficient lithium ion transport interaction between the lithium metal and the SSE 130.

The cathode 140 may be formed of various materials including those in the art for lithium ion cathodes, including lithiated and nonlithiated cathodes. In some examples, the cathode 140 includes or is formed of a lithium intercalation material. In some examples, the cathode 140 includes or is formed of a lithium cobalt oxide, a lithium nickel manganese cobalt oxide (LiNiₓMn_{y}Co_{1-x-y}O₂; NMC) or a lithium nickel manganese oxide (spinel LiNi_{0.5}Mn_{1.5}O₄; LNMO).

The cathode-side current collector 150 may be formed of various materials including those used in the art for lithium ion cathode current collectors. In some examples, the cathode-side current collector 150 may include or be formed of aluminum or an alloy thereof.

FIG. 1 presents the lithium ion cell 100 in an uncycled, as-assembled state which includes the initial lithium metal layer 170 between the anode-side current collector 110 and the lithiophilic layer 120. Upon cycling of the lithium ion cell 100, the initial lithium metal layer 170 is consumed and diffused as lithium ions (Li⁺) through the SSE 130, and stored in the cathode 140.

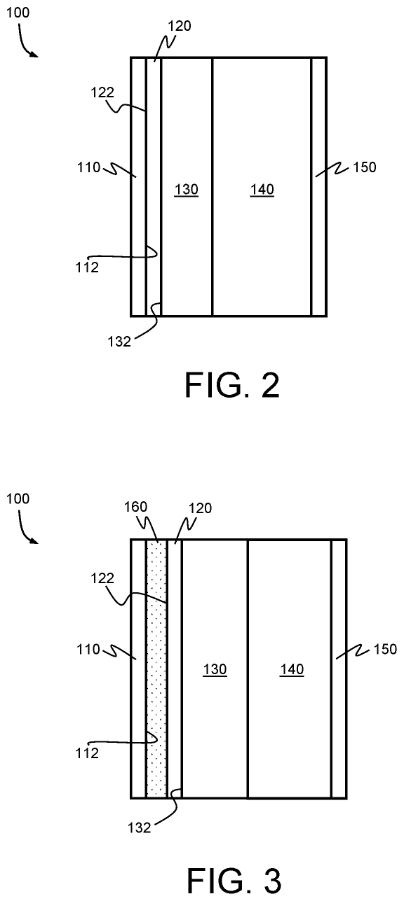

FIGS. 2 and 3 illustrate cycling of the lithium ion cell 100 which is presented in a discharged and charged state, respectively. In the discharged state (FIG. 2), the anode-side current collector 110 and the lithiophilic layer 120 are in contact and/or substantially proximate to each other. In the charged state (FIG. 3), a plated lithium layer 160 of lithium metal is between the lithiophilic layer 120 and the anode-side current collector 110. The lithium ion cell 100 may be repeatedly cycled (i.e., charged and/or discharged) to transition between the charged and discharged states. During a charging cycle, lithium ions (Li⁺) from the cathode 140 are reduced, diffused through the SSE 130, and plated as lithium metal (Li⁰) on the anode-side current collector 110 to form the plated lithium layer 160. During a discharging cycle, the plated lithium layer 160 is stripped from the anode-side current collector 110, diffused as lithium ions through the SSE 130, and returned to the cathode 140. As represented in FIGS. 2 and 3, the lithium ion cell 100 undergoes volumetric changes during cycling due to the stripping and plating of the lithium metal.

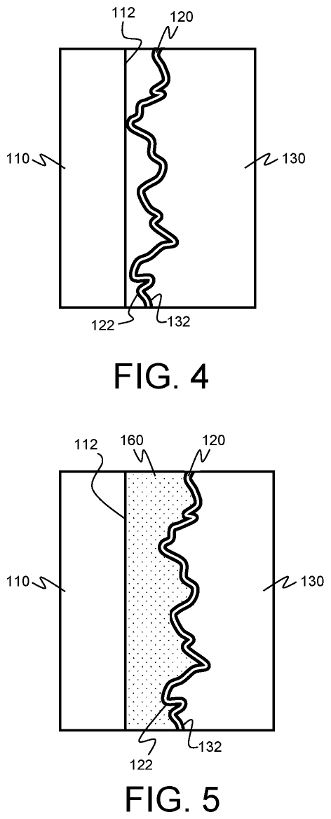

FIGS. 4 and 5 present enlarged views of an interface between the SSE 130 and the anode-side current collector 110 in the discharged and charged states, respectively. A significant challenge with SSEs in general is achieving a conformal low-impedance interfacial contact between the SSE and the plated lithium metal. In the present example, the lithiophilic layer 120 promotes wettability between the plated lithium layer 160 and the surface 132 of the SSE 130 such that high quality (e.g., conformal low-impedance) interfacial contact is achieved between the surface 132 of the SSE 130 and the plated lithium layer 160.

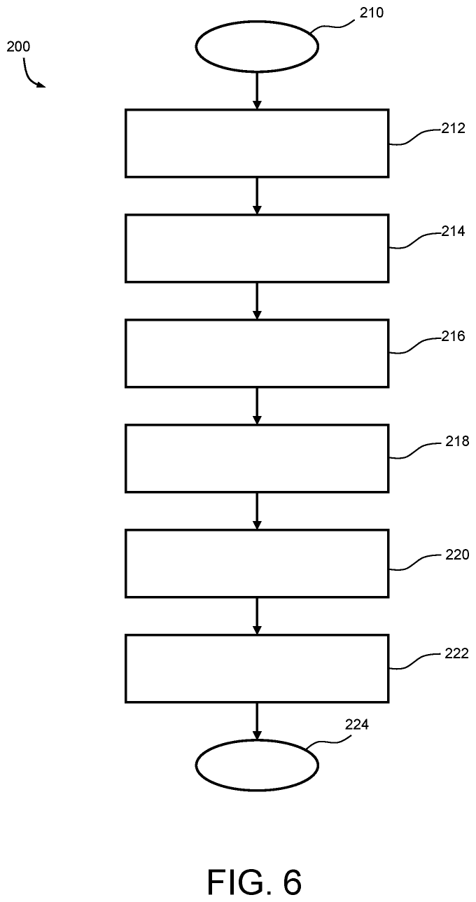

With reference now to FIG. 6 and with continued reference to FIGS. 1-5, a flowchart provides a method 200 for promoting lithium metal wettability of an SSE (e.g., the SSE 130) in accordance with examples. As can be appreciated in light of the disclosure, the order of operation within the method 200 is not limited to the sequential execution as illustrated in FIG. 6, but may be performed in one or more varying orders as applicable and in accordance with the present disclosure.

In one example, the method 200 may start at 210. At 212, the method 200 may include providing, receiving, or forming an SSE. Processes for forming the SSE are known in the art and will not be described in detail herein. The SSE may include or be formed of various materials including those discussed previously in relation to the SSE 130.

At 214, the method 200 may include applying or depositing a precursor solution on a surface of the SSE. The precursor solution may include various materials and compositions suitable for forming a lithiophilic layer on the surface of the SSE. In various examples, the precursor solution is a non-aqueous solution that includes a metallic nitrate. In various examples, the precursor solution includes zinc nitrate (Zn(NO₃)₂), indium nitrate (In(NO₃)₃), tin nitrate (Sn(NO₃)₄), aluminum nitrate (Al(NO₃)₃), or bismuth nitrate (Bi(NO₃)₃).

The precursor solution may be deposited onto the surface of the SSE by various processes. In some examples, the precursor solution may be deposited onto the surface of the SSE by a spin coating process. In such examples, a thickness of the lithiophilic layer may be controlled by controlling a concentration of the metallic nitrate in the precursor solution, and by controlling, during spin coating process, a rotational speed of the SSE, a temperature of the SSE, and distance between the surface of the SSE and a source of the precursor solution.

At 216, the method 200 may include performing a heat treatment on the deposited precursor solution at or above a decomposition temperature of the metallic nitrate for a time sufficient to decompose the precursor solution and form a conformal lithiophilic layer (e.g., the lithiophilic layer 120) directly on and in contact with the surface of the SSE (e.g., surface 132). In some examples, the lithiophilic layer includes or is formed of a metal oxide (e.g., ZnO, In₂O₃, SnO, SnO₂, Al₂O₃, or Bi₂O₃). In some examples, the heat treatment may include exposing the applied precursor solution to temperatures in a range of about 30° C. to about 500° C. As nonlimiting examples, heat treatments for precursor solutions having nitrate salts of Al, In, Zn, Sn, and Bi may include temperatures of at least 150° C., 250° C., 500° C., 90° C., and 30° C., respectively.

At 218, the method 200 may include providing, receiving, or forming a current collector (e.g., the anode-side current collector 110). Processes for forming the current collector are known in the art and will not be described in detail herein. The current collector may include or be formed of various materials including those discussed previously in relation to the anode-side current collector 110.

At 220, the method 200 may include locating lithium metal between the lithiophilic layer and the current collector to form an initial lithium metal layer. In some examples, the lithium metal may be, for example, a thin film located between the lithiophilic layer and the current collector. In such examples, a pressing process may be performed to form the assembly. Due to the presence of the lithiophilic layer, the pressing process may be performed at a pressure below 100 MPa, which is below typical pressures used in the art to promote a suitable interface between the lithium metal and the SSE. In some alternative examples, the lithium metal may be heated to a temperature sufficient to achieve a flowable, molten state, the molten lithium metal may be conformably deposited in a space between the lithiophilic layer and the current collector, and the lithium metal may be cooled to form a solid and thereby form the lithium metal anode.

At 222, the method 200 may further include installing or assembling the lithium metal anode, the SSE, and a cathode to define a lithium ion cell (e.g., the lithium ion cell 100). The method 200 may end at 224.

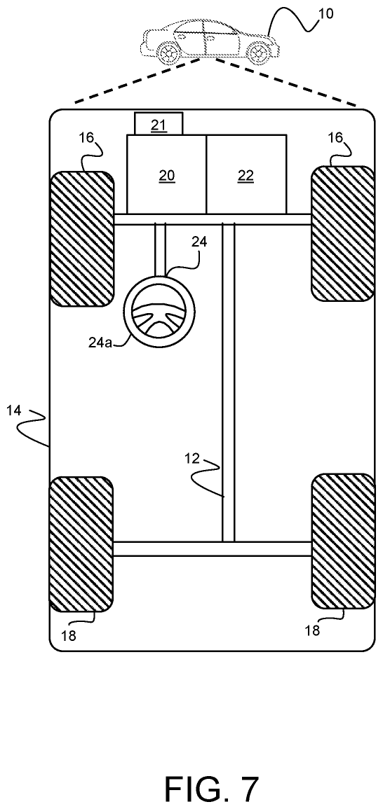

With reference now to FIG. 7, a vehicle 10 is provided according to an example. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain examples.

As depicted in FIG. 7, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

The vehicle 10 further includes a propulsion system 20, a transmission system 22, a steering system 24, and at least one lithium ion battery 21. The propulsion system 20 includes an electric motor or a hybrid electric motor and combustion engine. The transmission system 22 is configured to transmit power from the propulsion system 20 to the wheels 16-18 according to selectable speed ratios. According to various examples, the transmission system 22 may include a step-ratio automatic transmission, a continuously-variable transmission, or other appropriate transmission. The steering system 24 influences a position of the wheels 16-18. While depicted as including a steering wheel for illustrative purposes, in some examples contemplated within the scope of the present disclosure, the steering system 24 may not include a steering wheel. The propulsion system 20 receives electrical power from the at least one lithium ion battery 21 suitable for powering operation of the propulsion system 20 and/or components thereof (e.g., the electric motor). The lithium ion battery 21 may include one or more lithium ion cells such as the lithium ion cell 100 of FIGS. 1-5.

The lithium ion cells, batteries, and methods disclosed herein provide various benefits over certain existing lithium ion cells, batteries, and methods. For example, a significant challenge with SSEs in general is achieving a conformal low-impedance interfacial contact between the SSE and the lithium metal. In the present example, the lithiophilic layer 120 promotes wettability between the lithium metal and the surface 132 of the SSE 130 and promotes a low interfacial resistance. As such, the presence of the lithiophilic layer 120 may promote reduced lithium inventory loss, improved cycle life, improved cell performance, and extended usable life span.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A lithium ion cell, comprising:
a lithium metal anode that includes a current collector and a lithium metal layer;
a cathode having a lithium intercalation material; and
a solid-state electrolyte (SSE) having a lithiophilic layer on a surface of the SSE, wherein the lithiophilic layer includes a metal oxide.

2. The lithium ion cell of claim 1, wherein the lithium ion cell is a hostless cell wherein lithium metal is plated on the current collector during charge of the lithium ion cell to define a plated lithium layer between the current collector and the lithiophilic layer.

3. The lithium ion cell of claim 1, wherein the lithiophilic layer has a thickness of between 20 nanometers to 100 nanometers.

4. The lithium ion cell of claim 1, wherein the metal oxide is an oxide of zinc, indium, tin, aluminum, or bismuth.

5. The lithium ion cell of claim 1, wherein the surface of the SSE is lithiophobic.

6. The lithium ion cell of claim 1, wherein the SSE is a garnet-type SSE (LLMO) that includes a composition comprising lithium, lanthanum, oxygen, and one of zirconium, niobium, or tantalum.

7. A method, comprising:
depositing a non-aqueous precursor solution on a surface of a solid-state electrolyte (SSE), wherein the precursor solution includes a metallic nitrate; and
decomposing the precursor solution to form a lithiophilic layer on the surface of the SSE, wherein the lithiophilic layer includes a metal oxide.

8. The method of claim 7, further comprising:
forming a lithium metal layer between the lithiophilic layer and a current collector to define a lithium metal anode that includes the current collector and the lithium metal layer; and
assembling the SSE between the lithium metal anode and a cathode to define a lithium ion cell, wherein the cathode includes a lithium intercalation material.

9. The method of claim 8, wherein the SSE and the lithium metal anode are assembled by performing a pressing process wherein the lithium metal layer is located between the current collector and the lithiophilic layer of the SSE at a pressure below 100 MPa.

10. The method of claim 8, wherein the SSE and the lithium metal anode are assembled by:
locating the current collector in proximity to the lithiophilic layer of the SSE; and
filling a space therebetween with molten lithium metal.

11. The method of claim 8, wherein the lithium ion cell is a hostless cell wherein the lithium ion cell is configured to have lithium metal plated on the current collector during charge of the lithium ion cell to define a plated lithium layer between the current collector and the lithiophilic layer of the SSE.

12. The method of claim 7, wherein the lithiophilic layer has a thickness of between 20 nanometers to 100 nanometers.

13. The method of claim 7, wherein the metal oxide is an oxide of zinc, indium, tin, aluminum, or bismuth.

14. The method of claim 7, wherein depositing the precursor solution is performed by a spin coating process.

15. The method of claim 14, further comprising controlling a thickness of the lithiophilic layer by controlling a concentration of the metallic nitrate in the precursor solution, and by controlling, during the spin coating process, a rotational speed of the SSE, a temperature of the SSE, and distance between the surface of the SSE and a source of the precursor solution.

16. The method of claim 7, wherein the SSE is a garnet-type SSE (LLMO) that includes a composition comprising lithium, lanthanum, oxygen, and one of zirconium, niobium, or tantalum.

17. A vehicle, comprising:
a lithium ion battery including a lithium ion cell, wherein the lithium ion cell includes:
a lithium metal anode that includes a current collector and a lithium metal layer;
a cathode having a lithium intercalation material; and
a solid-state electrolyte (SSE) having a lithiophilic layer on a surface of the SSE, wherein the lithiophilic layer includes a metal oxide, wherein the surface of the SSE is lithiophobic,
wherein lithium metal is plated on the current collector during charge of the lithium ion cell to define a plated lithium layer between the current collector and the lithiophilic layer; and
a propulsion system configured to receive electric power from the lithium ion battery.

18. The vehicle of claim 17, wherein the lithiophilic layer has a thickness of between 20 nanometers to 100 nanometers.

19. The vehicle of claim 17, wherein the metal oxide is an oxide of zinc, indium, tin, aluminum, or bismuth.

20. The vehicle of claim 17, wherein the SSE is a garnet-type SSE (LLMO) that includes a composition comprising lithium, lanthanum, oxygen, and one of zirconium, niobium, or tantalum.
